(19) United States
(12) Patent Application Publication
(10) Pub. No.: US 2022/0341564 A1
(43) Pub. Date: Oct. 27, 2022

(54) Light Gathering and Diffusing Illuminated Lens

(71) Applicant: NightStar Traffic Solutions, Inc., Westminster, CO (US)

(72) Inventor: Mariteresa Boren Glass, Westminster, CO (US)

(21) Appl. No.: 17/861,494

(22) Filed: Jul. 11, 2022

Related U.S. Application Data
(63) Continuation of application No. 17/184,475, filed on Feb. 24, 2021.
(60) Provisional application No. 62/980,534, filed on Feb. 24, 2020.

(51) Int. Cl. F21V 5/00; F21V 15/01; G02B 5/02; F21V 31/00

(52) U.S. Cl. CPC F21V 5/00; F21V 15/012; G02B 5/0242; F21V 31/005; F21W 2111/02

(57) ABSTRACT

A light gathering and diffusing illuminated lens is shown and described herein.

### FIELD OF THE INVENTION

The present invention relates generally to illuminated lens. More specifically, the present invention is an illuminated lens that can absorb, redirect, and/or diffuse light.

### BACKGROUND OF THE INVENTION

Currently, driving is common facet of present society. Often, driving can occur during non-daylight times or during weather in which there is not enough light during the day. During these periods, or other related circumstances, the driver often has to rely on illuminated “reflective” road signs in order to view these road signs. Often, these illuminated “reflective” road signs can have a light source that is directed to the road signs in order to illuminate them. However, this can be cumbersome and/or ineffective to employ on road signs that are smaller than the road signs employed for major road infrastructures like highways and such. Instead, these smaller road signs often utilize specific properties or features that allow these road signs to redirect or reflect from an oncoming vehicle. However, it is often found that the light being redirected or reflected from these smaller road signs can be harsh, glaring, and/or too intense to the driver of the said oncoming vehicle. Additionally, currently, there are no illuminated road signs in which illumination aspects of the signs (such as color, intensity, rhythm, and other properties) can be controlled and programmed by a user.

An objective of the present invention is to provide users with a device that is a light gathering and diffusing illuminated lens. The present invention intends to provide users with a device that can absorb, gather, or accept light from a light source attached to the present invention. The present invention intends to provide users with a device that can redirect said light towards the front of the present invention and/or away from the rear of the present invention. The present invention intends to provide users with a device that can diffuse said light to limit the brightness and/or intensity of said light prior to the said light exiting the present invention from the front of the present invention. The present invention intends to provide users with a device that contains a measure for preventing any of said light from leaking through the rear of the present invention. The present invention intends to provide users with a light array with means for the user to control and/or program various properties of the light. Another objective of the present invention is to provide users with a device that reduce and/or eliminate glare, eye strain, and/or overly bright signage products.

### SUMMARY OF THE INVENTION

The present invention is a light gathering and diffusing illuminated lens. The present invention primarily contains a first casing and a second casing. The present invention contains a first panel through a seventh panel and a gasket within the first casing and second casing. The fourth panel contains a light array on both side faces of the fourth panel. The light array contains a plurality of light sources, a circuitry, and/or a software application. The software application allows the user to control various properties/parameters of the plurality of light sources of the light array. The circuitry can contain a power source to operate the plurality of light sources. The present invention contains a gasket in between the first panel and the second panel. The present invention can contain a graphic on the front face of the first casing.

### BRIEF DESCRIPTION OF THE DRAWINGS

FIG. 1 is a perspective view of the present invention.

FIG. 2 is a front/rear view of the present invention.

FIG. 3 is a right/left side view of the present invention.

FIG. 4 is a top/bottom view of the present invention.

FIG. 5 is an exploded view of the present invention.

FIG. 6 is a perspective view of a casing of the present invention.

FIG. 7 is a front view of a casing of the present invention.

FIG. 8 is a rear view of a casing of the present invention.

FIG. 9 is a top/bottom view of a casing of the present invention.

FIG. 10 is a right/left side view of a casing of the present invention.

FIG. 11 is a cross-sectional view of a casing taken along line 11-11 in FIG. 7.

FIG. 12 is a perspective view of a gasket of the present invention.

FIG. 13 is a front/rear view of a gasket of the present invention.

FIG. 14 is a top/bottom view of a gasket of the present invention.

FIG. 15 is a perspective view of a panel of the present invention.

FIG. 16 is a front/rear view of a panel of the present invention.

FIG. 17 is a perspective view of the fourth panel of the present invention.

FIG. 18 is a front/rear view of the fourth panel of the present invention.

FIG. 19 is a right/left side view of the fourth panel of the present invention.

FIG. 20 is a top/bottom view of the fourth panel of the present invention.

### DETAIL DESCRIPTIONS OF THE INVENTION

All illustrations of the drawings are to be describing selected versions of the present invention and are not intended to limit the scope of the present invention. All references of user or users pertain to either individual or individuals who would utilize the present invention.

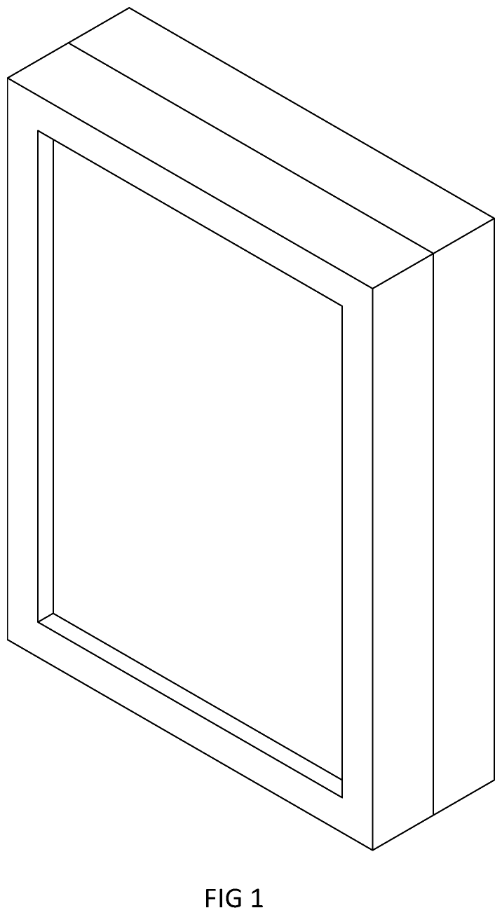

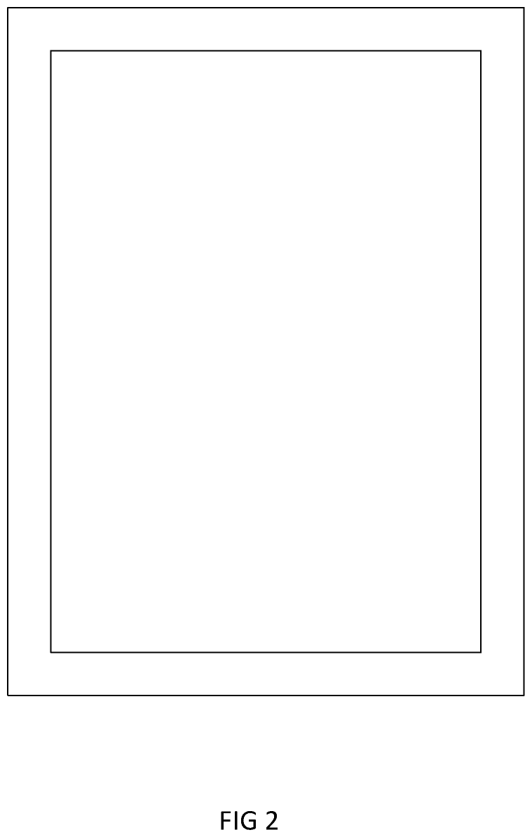

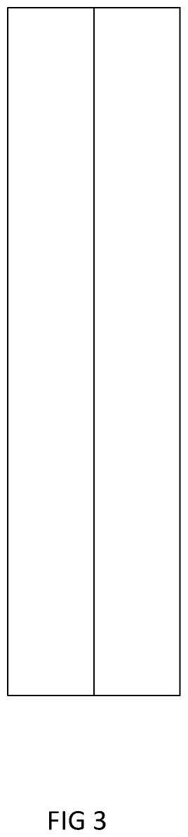

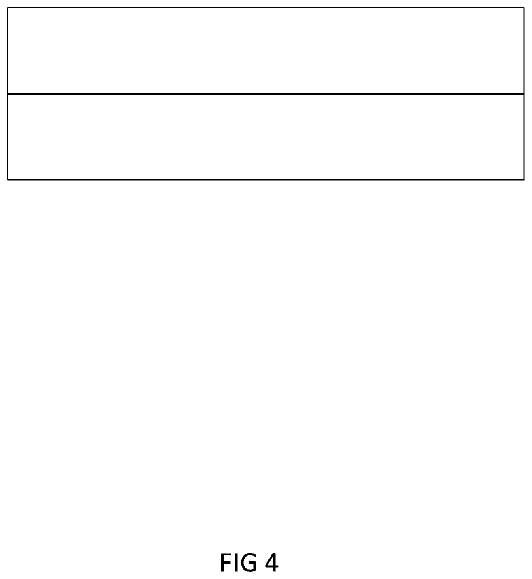

As seen in FIG. 1 through FIG. 5, the present invention is a light gathering and diffusing illuminated lens. The present invention can be of any shape, size, material, features, type or kind, orientation, location, quantity, components, and arrangements of components that would allow the present invention to fulfill the objectives and intents of the present invention. The present invention can primarily include a first casing, a second casing, a first panel through a seventh panel, a gasket, and a circuit board. In an alternative embodiment of the present invention, the present invention can contain a layer that can be similar to a graphic, a sign, an illustration, an image, other similarly-related objects, a plurality of the above-mentioned, and/or a combination of the above-mentioned on the exposed, exterior surfaces of the front of the present invention.

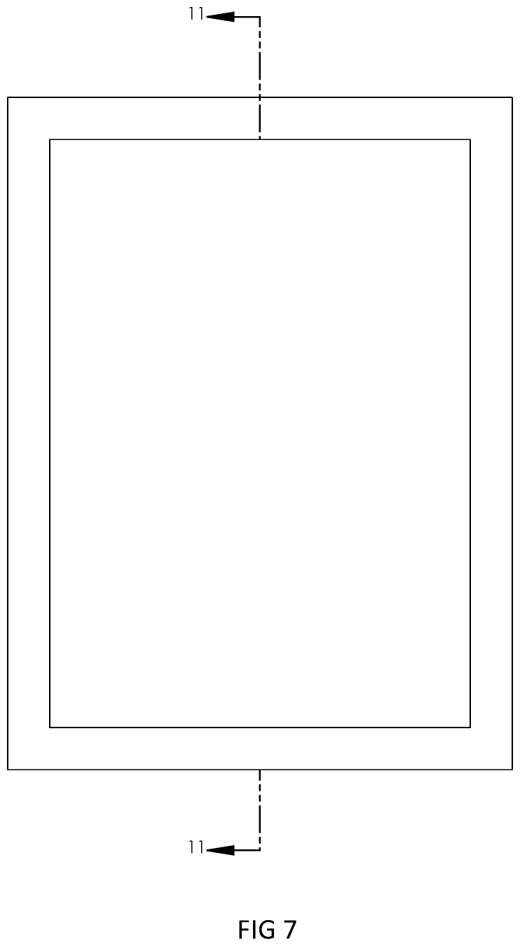

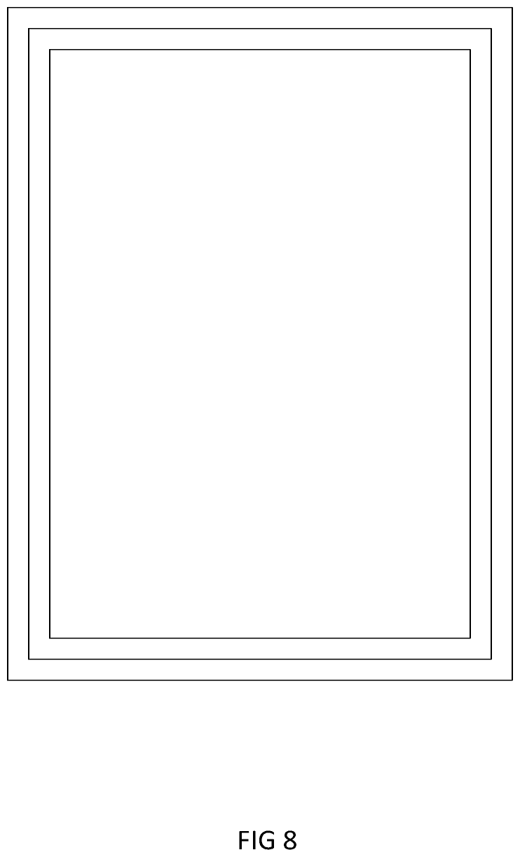

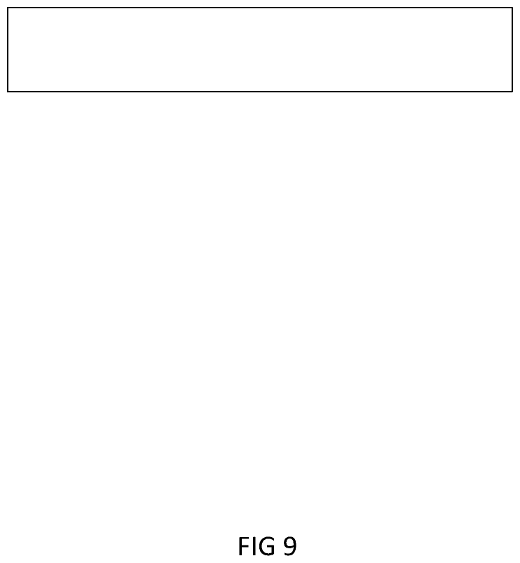

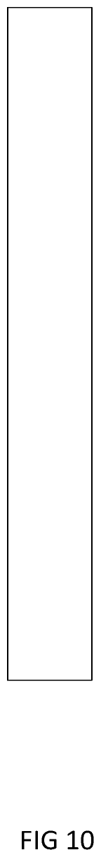

As seen in FIG. 1 through FIG. 11, the present invention contains a first casing. The first casing can be of any shape, size, material, features, type or kind, orientation, location, quantity, components, and arrangements of components that would allow the present invention to fulfill the objectives and intents of the present invention. However, it can be preferred that the first casing be of a material that is strong, durable, tough, impact resistant, tamper proof, lightweight, ergonomically, and/or easily manufacturable. Such a material can include, but is not limited to, the following: aluminum, other similar metals, plastic, and/or any combination of the abovementioned. It can be preferred that the first casing be of a length similar to half the length of the present invention. It can be preferred that the first casing be of a width and height similar to the width and height of the present invention. The first casting primarily includes a first cavity and a second cavity.

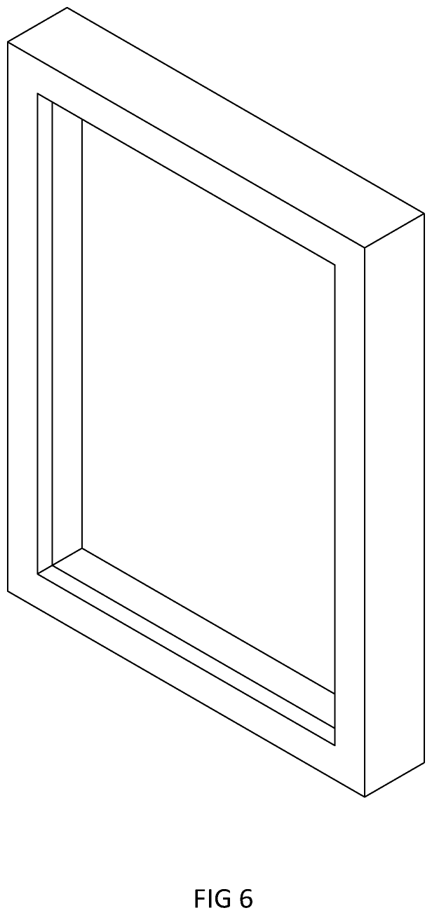

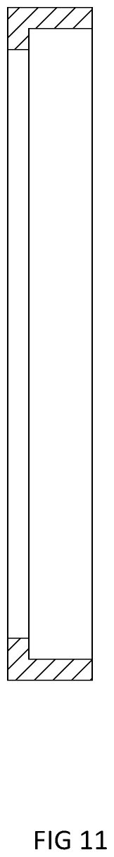

As seen in FIG. 6 through FIG. 8 and in FIG. 11, the first casing contains a first cavity and a second cavity. The first cavity can be of any shape, size, material, features, type or kind, orientation, location, quantity, components, and arrangements of components that would allow the present invention to fulfill the objectives and intents of the present invention. However, it can be preferred that the first cavity be of shape similar to the shape of the first casing. It can be preferred that the first cavity be of a perimeter smaller than the perimeter of the rear face of the first casing. It can be preferred that the first cavity be of a depth that is slightly smaller than the length of the first casing. It can be preferred that the first cavity be located centrally on the rear face of the first casing. The second cavity can be of any shape, size, material, features, type or kind, orientation, location, quantity, components, and arrangements of components that would allow the present invention to fulfill the objectives and intents of the present invention. However, it can be preferred that the second cavity be located centrally on the rear face of the first cavity. It can be preferred that the second cavity be of a shape similar to the shape of the first cavity. It can be preferred that the second cavity be of a perimeter that is slightly smaller than the perimeter of the first cavity. It can be preferred that the second cavity be of a depth that is similar to the length of the first casing.

As seen in FIG. 1 through FIG. 11, the present invention contains a second casing. The second casing can be of any shape, size, material, features, type or kind, orientation, location, quantity, components, and arrangements of components that would allow the present invention to fulfill the objectives and intents of the present invention. However, it can be preferred that the second casing be identical to the first casing in shape, size, material, features, type or kind, quantity, components, and arrangements of components. It can be preferred that the second casing be located and orientated such that the rear face of the first casing is attached to the rear face of the second casing as illustrated in FIG. 1 through FIG. 5. The second casing can contain a third cavity and a fourth cavity. The third cavity can be of any shape, size, material, features, type or kind, orientation, location, quantity, components, and arrangements of components that would allow the present invention to fulfill the objectives and intents of the present invention. However, it can be preferred that the third cavity be identical to the first cavity in shape, size, material, features, type or kind, orientation, location, quantity, components, and arrangements of components. The fourth cavity can be of any shape, size, material, features, type or kind, orientation, location, quantity, components, and arrangements of components that would allow the present invention to fulfill the objectives and intents of the present invention. However, it can be preferred that the fourth cavity be identical to the second cavity in shape, size, material, features, type or kind, orientation, location, quantity, components, and arrangements of components.

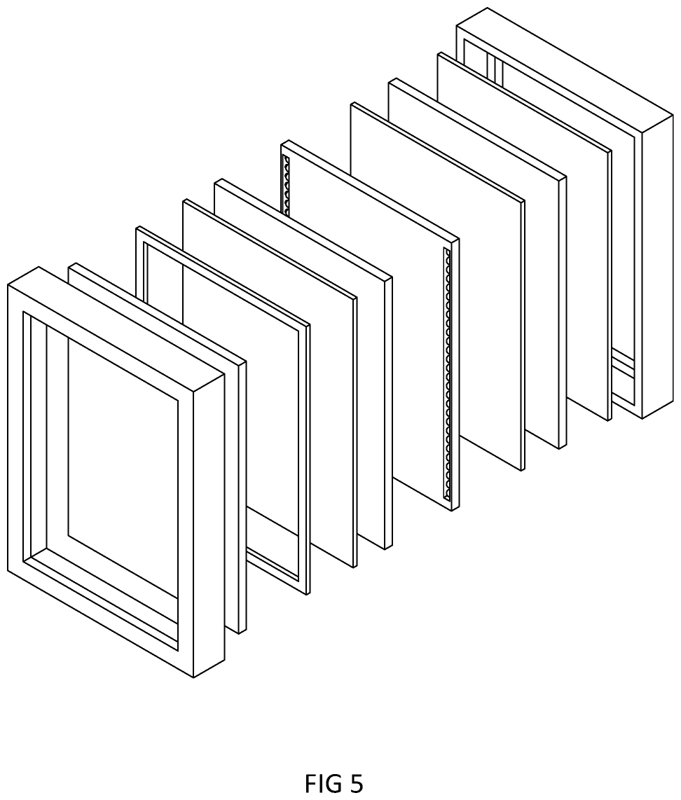

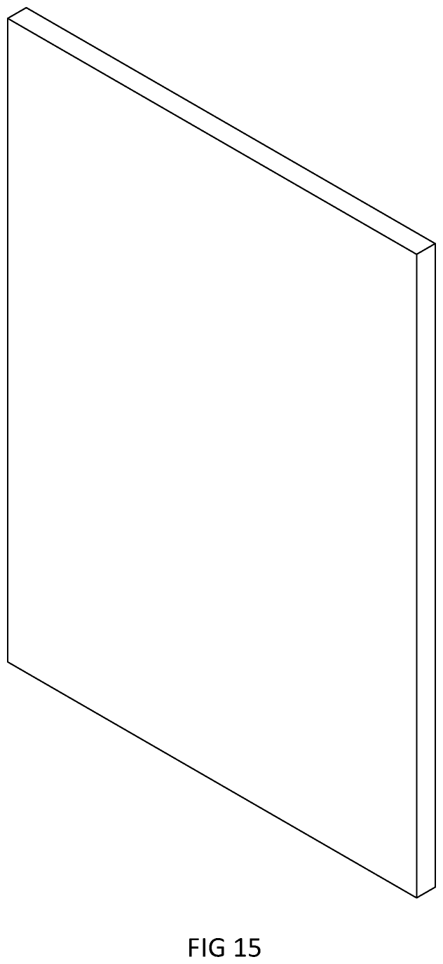

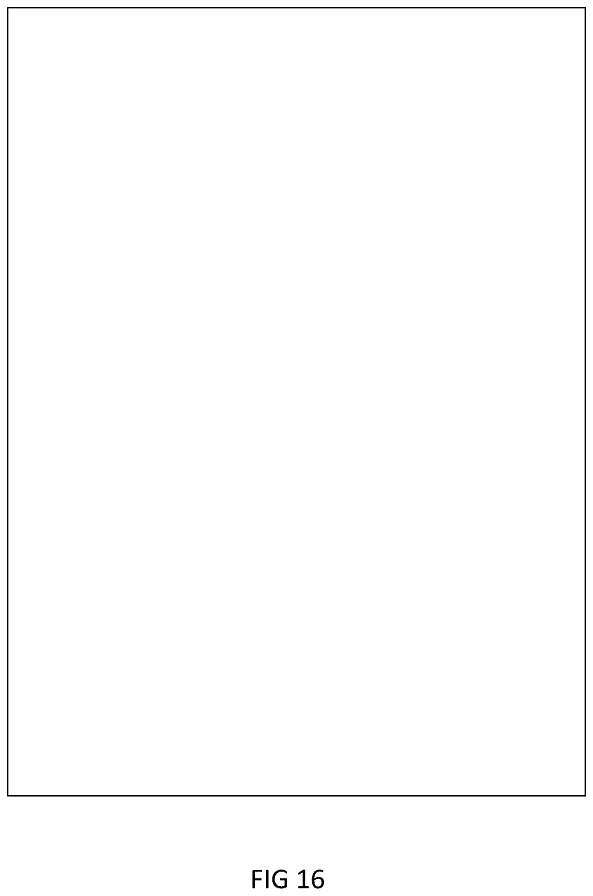

As seen in FIG. 5 and in FIG. 15 through FIG. 16, the present invention contains a first panel. The first panel can be of any shape, size, material, features, type or kind, orientation, location, quantity, components, and arrangements of components that would allow the present invention to fulfill the objectives and intents of the present invention. However, it can be preferred that the first panel be of a material that is tough, strong, durable, impact resistant, shatter-proof, resistant to ultraviolet light, scratch resistant or scratch-proof, resistant to chemicals, abrasion proof, lightweight, transparent, stiff, and/or easily manufacturable. Such a material can include, but is not limited to, the following: PMMA acrylic glass, other similar plastics, and/or a combination of the aforementioned. It can be preferred that the first panel be of shape similar to the shape of the first cavity of the first casing. It can be preferred that the first panel be of a width and height (, or perimeter,) similar to the width and height (, or perimeter) of the first cavity. It can be preferred that the first panel be of a length that smaller than the depth of the first cavity of the first casing. It can be preferred that the first panel be located such that the front face of the first panel is connected to the inner surfaces of the front face of the first cavity, as illustrated in FIG. 5.

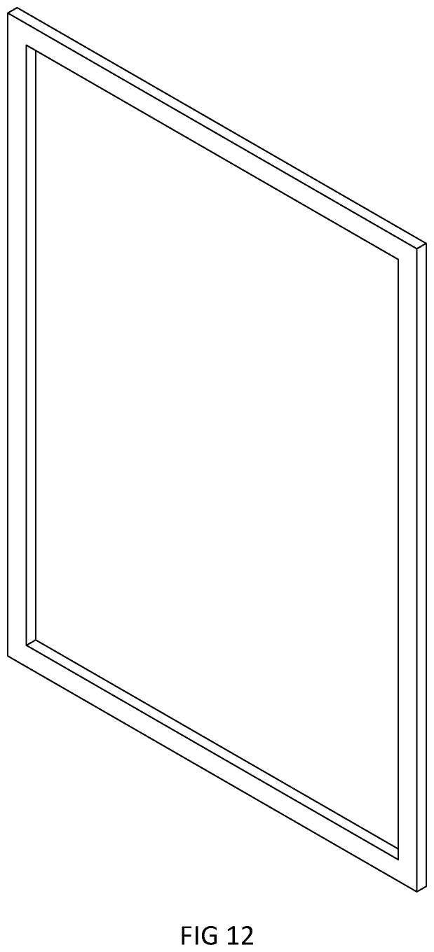

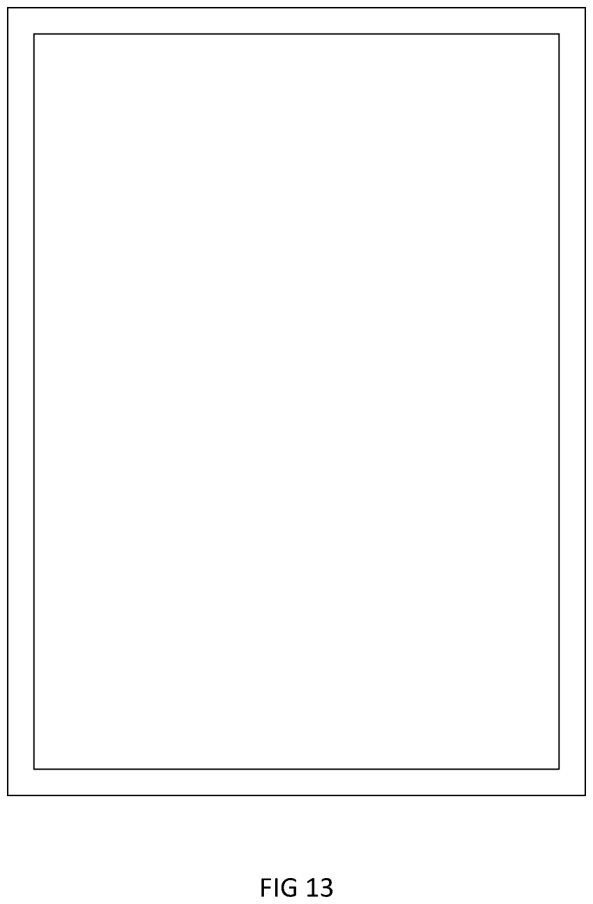

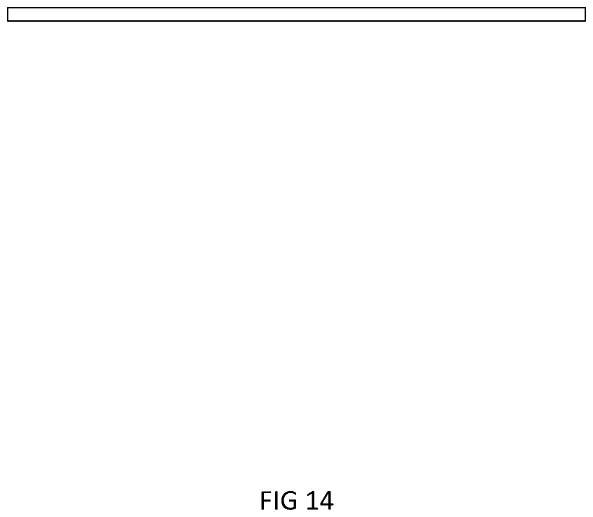

As seen in FIG. 5 and in FIG. 12 through FIG. 14, the present invention contains a gasket. The gasket can be of any shape, size, material, features, type or kind, orientation, location, quantity, components, and arrangements of components that would allow the present invention to fulfill the objectives and intents of the present invention. However, it can be preferred that the gasket be of a material that is compatible with the material of first panel, while also being soft, smooth, non-slip material, non-abrasive, moisture sealing and/or wicking, and/or elastic. It can be preferred that the gasket be of a shape and shape identical or similar to the shape and size of the first panel. It can be preferred that the gasket contain a fifth cavity that can be of any shape, size, material, features, type or kind, orientation, location, quantity, components, and arrangements of components that would allow the present invention to fulfill the objectives and intents of the present invention. However, it can be preferred that the fifth cavity be identical to the second cavity of the first casing in shape, size, material, features, type or kind, orientation, quantity, components, and arrangements of components. It can also be preferred that the fifth cavity be of located centrally of the front face of the gasket and be of a depth similar to the length of the gasket. It can be preferred that the gasket be located and orientated such that the front face of gasket is connected to the rear face of a first panel.

As seen in FIG. 5 and in FIG. 15 through FIG. 16, the present invention contains a second panel. The second panel can be of any shape, size, material, features, type or kind, orientation, location, quantity, components, and arrangements of components that would allow the present invention to fulfill the objectives and intents of the present invention. However, it can be preferred that the second panel be similar to the first panel in shape, size, orientation, quantity, components, and arrangements of components. It can be preferred that the second panel be of a material similar to and/or compatible with the material of the first panel. It can be preferred that the second panel be of features or a type or kind similar to a light beam filter such that the second panel can adjust a light beam's angle and shape in order to refocus said light beam to control and flatten the direction of said light beam and reduce/prevent wasted said light beam and potential light pollution. It can be preferred that the second panel be located such that the front face of the second panel is connected to the rear face of the gasket.

As seen in FIG. 5 and in FIG. 15 through FIG. 16, the present invention contains a third panel. The third panel can be of any shape, size, material, features, type or kind, orientation, location, quantity, components, and arrangements of components that would allow the present invention to fulfill the objectives and intents of the present invention. However, it can be preferred that the third panel be similar to the first panel in shape, size, orientation, quantity, components, and arrangements of components. It can be preferred that the third panel be of a material similar to and/or compatible with the material of the first panel, while also being of a cloudy or satin-like finish and of a transparency significantly lesser than the transparency of the first panel. It can be preferred that the third panel be of features or a type or kind similar to a light beam diffuser such that the third panel can soften a light beam to reduce and/or remove glare, hot spots, and/or shadows. It can be preferred that the third panel be located such that the front face of the third panel is connected to the rear face of the second panel. Also, it can be preferred that the third panel contain a first plurality of particles. The first plurality of particles can be of any shape, size, material, features, type or kind, orientation, location, quantity, components, and arrangements of components that would allow the present invention to fulfill the objectives and intents of the present invention. However, it can be preferred that the first plurality of particles be of the type or kind, features, material, and/or components similar to light diffusing particles. It can be preferred that the first plurality of particles be embedded within and dispersed throughout the third panel such that first plurality of particles can soften a light beam to reduce and/or remove glare, hot spots, and/or shadows.

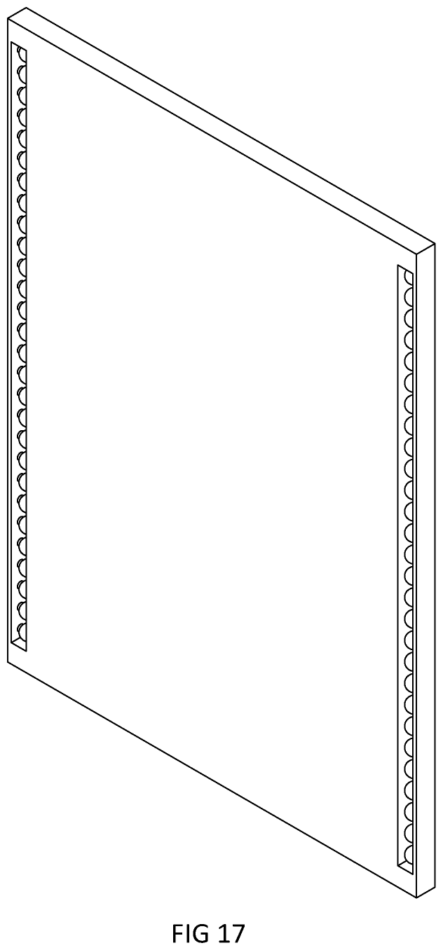

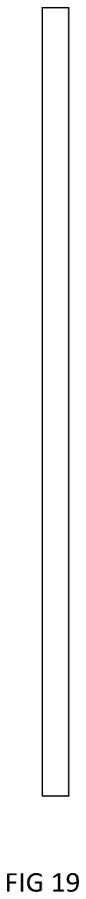

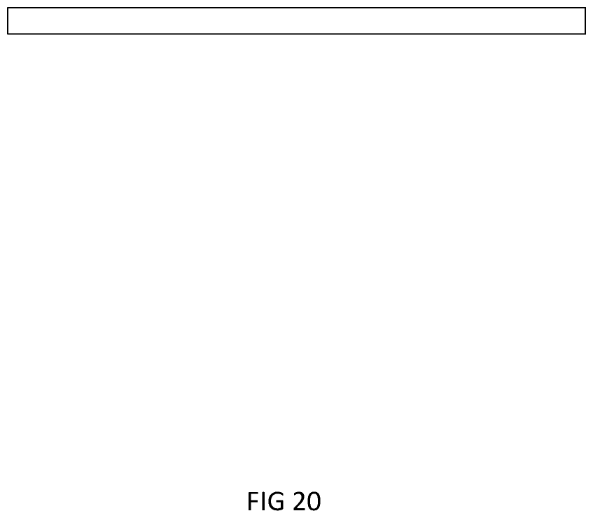

As seen in FIG. 5 and in FIG. 17 through FIG. 20, the present invention contains a fourth panel. The fourth panel can be of any shape, size, material, features, type or kind, orientation, location, quantity, components, and arrangements of components that would allow the present invention to fulfill the objectives and intents of the present invention. However, it can be preferred that the fourth panel be similar to the first panel in shape, size, orientation, quantity, components, and arrangements of components. It can be preferred that the fourth panel be of a material similar to and/or compatible with the material of the first panel. It can be preferred that the side faces of the fourth panel be of a smooth surface. It can be preferred that the fourth panel be located such that the front face of the fourth panel is connected to the rear face of the third panel. The fourth panel primarily includes a second plurality of particles, a first light array, and a second light array. The second plurality of particles can be of any shape, size, material, features, type or kind, orientation, location, quantity, components, and arrangements of components that would allow the present invention to fulfill the objectives and intents of the present invention. However, it can be preferred that then second plurality of particles be a material, type or kind, features, and/or components such that a light beam from the first light array and the second light array can be transformed into a light beam that is of a smooth and/or evenly dispersed illumination, which can be reflected and/or redirected towards the front of the present invention. It can be preferred that the second plurality of particles be located within and/or dispersed throughout the fourth panel such that the second plurality of particles such that a light beam can be reflected and/or redirected towards the front of the present invention.

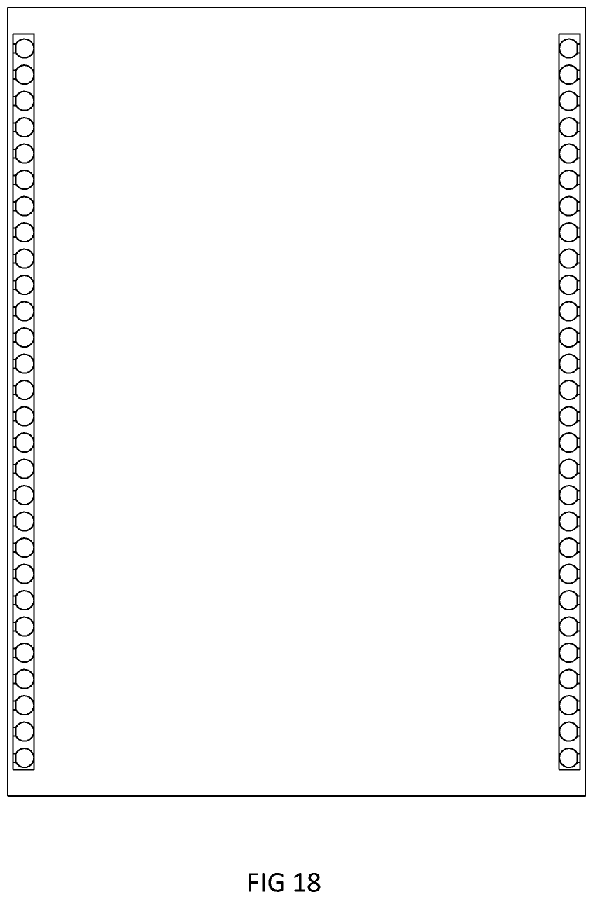

As seen in FIG. 5 and in FIG. 17 through FIG. 18, the fourth panel contains a first light array. The first light array can be of any shape, size, material, features, type or kind, orientation, location, quantity, components, and arrangements of components that would allow the present invention to fulfill the objectives and intents of the present invention. However, it can be preferred that the first light array be of a material that is compatible with the material of the present invention. It can be preferred that the first light array be located on a side face of the fourth panel. It can be preferred that the first light array be of a length and height similar to the length and height of the fourth panel. It can be preferred that the first light array be of a width similar to the difference of widths between the width of the first cavity and the width of the second cavity of the first casing. The first light array can include a first plurality of light emitting devices. The first plurality of light emitting devices can be of any shape, size, material, features, type or kind, orientation, location, quantity, components, and arrangements of components that would allow the present invention to fulfill the objectives and intents of the present invention. However, it can be preferred that the first plurality of light emitting devices be orientated such that the first plurality of light emitting devices emit light beams towards the center of the fourth panel from the side face of the fourth panel on which the first light array is located. It can be preferred that the first plurality of light emitting devices be of the type or kind, features, components similar to, but not limited to, the following: light emitting diodes, organic light emitting diodes, light bulbs, liquid crystal displays, and other similarly related devices.

As seen in FIG. 5 and in FIG. 17 through FIG. 18, the fourth panel contains a second light array. The second light array can be of any shape, size, material, features, type or kind, orientation, location, quantity, components, and arrangements of components that would allow the present invention to fulfill the objectives and intents of the present invention. However, it can be preferred that the second light array be identical to the first light array in shape, size, material, features, type or kind, orientation, quantity, components, and arrangements of components. It can be preferred that the second light array be located on the side face of the fourth panel opposite from the side face of the fourth panel that contains the first light array. The second light array can contain a second plurality of light emitting devices. The second plurality of light emitting devices can be of any shape, size, material, features, type or kind, orientation, location, quantity, components, and arrangements of components that would allow the present invention to fulfill the objectives and intents of the present invention. However, it can be preferred that the second plurality of light emitting devices can be identical to the first plurality of light emitting devices in shape, size, material, features, type or kind, orientation, location, quantity, components, and arrangements of components.

As seen in FIG. 5 and in FIG. 15 through FIG. 16, the present invention contains a fifth panel. The fifth panel can be of any shape, size, material, features, type or kind, orientation, location, quantity, components, and arrangements of components that would allow the present invention to fulfill the objectives and intents of the present invention. However, it can be preferred that the fifth panel be similar to the first panel in shape, size, orientation, quantity, components, and arrangements of components. It can be preferred that the fifth panel be of a material similar to and/or compatible with the material of the first panel. It can be preferred that the fifth panel be of features or of a type or kind similar to a heat and/or moisture shield. It can be preferred that the fifth panel be located such that the front face of the fifth panel is connected to the rear face of the fourth panel.

As seen in FIG. 5 and in FIG. 15 through FIG. 16, the present invention contains a sixth panel. The sixth panel can be of any shape, size, material, features, type or kind, orientation, location, quantity, components, and arrangements of components that would allow the present invention to fulfill the objectives and intents of the present invention. However, it can be preferred that the sixth panel be similar to the first panel in shape, size, orientation, quantity, components, and arrangements of components. It can be preferred that the sixth panel be of features or of a type or kind similar to a reflector to force a light beam to exit towards to and at the front of the present invention. It can be preferred that the sixth panel be located such that the front face of the sixth panel is connected to the rear face of the fifth panel, as illustrated in FIG. 5.

As seen in FIG. 5 and in FIG. 15 through FIG. 16, the present invention contains a seventh panel. The seventh panel can be of any shape, size, material, features, type or kind, orientation, location, quantity, components, and arrangements of components that would allow the present invention to fulfill the objectives and intents of the present invention. However, it can be preferred that the seventh panel be similar to the first panel in shape, size, orientation, quantity, components, and arrangements of components. It can be preferred that the seventh panel be of a material similar to and/or compatible with the material of the first panel. It can be preferred that the seventh panel be of features or of a type or kind similar to a thermal heat foil such that the seventh panel can reduce heat transfer towards the rear face of the present invention while providing additional cushion and/or protection to the first panel through the sixth panel. It can be preferred that the seventh panel be located such that the front face of the seventh panel is connected to the rear face of the sixth panel, as illustrated in FIG. 5.

The present invention can contain a circuit board. The circuit board can be of any shape, size, material, features, type or kind, orientation, location, quantity, components, and arrangements of components that would allow the present invention to fulfill the objectives and intents of the present invention. However, it can be preferred that the circuit board be located within the present invention such that the circuit board can accessed and be within proximity to the first light array and the second light array. The circuit can contain an application. The application can be of any shape, size, material, features, type or kind, orientation, location, quantity, components, and arrangements of components that would allow the present invention to fulfill the objectives and intents of the present invention. However, it can be preferred that the application be of the type or kind, features, and/or components such that the application can control the various properties of a light beam from the plurality of light emitting devices; such properties including, but not limited to, the following: intensity, brightness, level of white color, color, length or duration of use, rhythm, and/or other similarly-related properties. The circuit board can contain a power source. The power source can be of any shape, size, material, features, type or kind, orientation, location, quantity, components, and arrangements of components that would allow the present invention to fulfill the objectives and intents of the present invention. However, it can be preferred that the power source be of the type or kind, components, and/or features similar to, but not limited to, the following: battery cells, solar energy panels, other similarly related objects, and/or any combination of the above-mentioned. The circuit board can contain a plurality of sensors. The plurality of sensors can be of any shape, size, material, features, type or kind, orientation, location, quantity, components, and arrangements of components that would allow the present invention to fulfill the objectives and intents of the present invention. However, it can be preferred that the plurality of sensors be of the type or kind, features, and/or components similar to, but not limited to, the following: photoelectric sensor, photodetector, any other similarly-related objects, and/or any combination of the above-mentioned.

Although the invention has been explained in relation to its preferred embodiment, it is to be understood that many other possible modifications and variations can be made without departing from the spirit and scope of the invention.

1. A light gathering and diffusing illuminated lens as shown and described herein.
